(19) United States
(12) Patent Application Publication
(10) Pub. No.: US 2005/0207653 A1
(43) Pub. Date: Sep. 22, 2005

(54) Method for analysis of line objects

(76) Inventor: Alexei V. Nikitin, Lawrence, KS (US)

Correspondence Address: Alexei V. Nikitin, 2131 Quail Creek Drive, Lawrence, KS, 66047, US

(21) Appl. No.: 11/080,785

(22) Filed: Mar. 15, 2005

Related U.S. Application Data
(60) Provisional application No. 60/553,664, filed on Mar. 16, 2004.
(60) Provisional application No. 60/574,824, filed on May 27, 2004.

(51) Int. Cl. G06K 9/00; G06K 9/18

(52) U.S. Cl. 382/202; 382/186

(57) ABSTRACT

The present invention relates to methods for conditioning, representation, modeling, characterization, identification, comparison, and analysis of variables. In particular, this invention is specially adapted for analysis of line objects such as, for example, human handwritten signatures. This invention also relates to generic measurement systems and processes, and to methods and corresponding apparatus for measuring which extend to different applications and provide results other than instantaneous values of variables. The invention further relates to post-processing analysis of measured variables and to statistical analysis. It is a method, processes, and apparatus for measurement and analysis of variables of different type and origin. In particular, this invention is specially adapted for analysis of (parametric) line objects such as, for example, human handwritten signatures. Particular embodiments of the invention may include various computer programs and simulation tools.

This non-provisional application claims the benefit of United States Provisional Patent Applications No. 60/553,664 entitled “Method for human handwriting characterization, identification, and comparison” filed on Mar. 16, 2004, and No. 60/574,824 entitled “Analog approach to analysis and modeling of biometric information” filed on May 27, 2004, which are incorporated herein by reference in their entirety.

### COPYRIGHT NOTIFICATION

Portions of this patent application contain materials that are subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present invention relates to methods for conditioning, representation, modeling, characterization, identification, comparison, and analysis of variables. In particular, this invention is specially adapted for analysis of line objects such as, for example, human handwritten signatures. This invention also relates to generic measurement systems and processes, and to methods and corresponding apparatus for measuring which extend to different applications and provide results other than instantaneous values of variables. The invention further relates to post-processing analysis of measured variables and to statistical analysis.

### BACKGROUND ART

Line objects Many objects in biometrics, networking, signal analysis, and many other fields related to representation of physical phenomena as well as behavioral characteristics of individuals can be classified as line (contour) objects. In general, a line object can be viewed as a piecewise continuous curve (a collection of continuous segments) with a collection (vector) of some values (‘features’) associated with each point of this curve. The feature vector can carry additional information describing the line object such as, for example, line density, color, the speed of writing and the exerted pressure along the drawn line, and other characteristics contingent on the physical nature of the object and the data acquisition device. Depending on the nature of a line object, the components (features) of the feature vector can be classified as geometric, static, kinematic, dynamic, and other features. For example, in networking, the infrastructure of a communication or transportation network can be presented as a line object which carries geometric information about the layout of the network (nodes and communication and/or transportation lines), and kinematic and dynamic information such as routes of individual particles and more general characteristics of capacity, throughput, and traffic. Note that, even though the composition of the feature vectors varies among different line object, all line objects have common infrastructure which is a piecewise continuous curve.

Inadequacy of representation of line objects in background art In the background art, the line objects are commonly represented by discrete (digital) records, and/or in a manner which is not independent of choice of coordinates and/or parameterization. Also, the representations of the known art are limited in their ability to be invariant with respect to those properties of line objects which are of little or no relevance to the characterization, identification, and comparison of line objects. The background art lacks a systematic approach to construction of such invariant representations, and uses only a limited choice of different variables of the representations which are representative (reflective) of different features of the line objects, and thus are relevant to different aspects of characterization, identification, comparison, and analysis of these objects.

Inadequacy of representation of line objects by discrete (digital) records The common piece-wise continuous infrastructure of a line object cannot be adequately represented by discrete records. Discrete records disallow description of the underlying continuous curves by means of differential calculus, which is the most appropriate tool for characterization of such curves.

Representation of a piecewise continuous curve by a discrete record always blurs the distinction between continuous and discontinuous portions of the curve. For example, the distance between the consecutive data points in a record acquired by a tablet device is proportional to the speed of the tip of the writing utensil and can exceed the distance between the end of one segment and the beginning of the other. Thus segmentation based on the distance between the consecutive data points may fail to accurately represent the curve as a collection of records corresponding to the underlying continuous segments.

In addition to discontinuities in the trajectory, line objects such as, for example, human handwritten signatures may contain various irregular and singular points. While those points may be important for adequate characterization of the line objects, discrete records disallow their accurate treatment.

Also, discrete records do not allow easy change in coordinates and parametrization of a curve, since this change commonly involves differentiation and accurate handling of singularities. For example, a change in parametrization from the physical time to arclength requires differentiation with respect to time and other limit operations, which might be an extremely challenging task for such irregular and discontinuous curves as those representing human handwriting. Another typical problems in digital representation of line objects is anisotropy of a digital grid. For example, the weight (e.g., number of pixels per unit length) of a line depends on its orientation on a rectangular grid.

The origin of the limitations of the existing art in representation of line objects thus can be identified as relying on digital records in the analysis of such objects, which impedes the geometrical interpretation of the measurements and leads to usage of algebraic rather than differential means of analysis. Further limitations of the current methods for conditioning and representation of digitally sampled line objects arise from the absence of tools for accurate representation of a curve given by a discrete sets of ordered data in terms a natural (or intrinsic) equation of the underlying continuous curve. An intrinsic equation specifies a curve independent of any choice of coordinates or parameterization (Yates, 1974). For example, a plane curve (a curve with zero torsion) can be naturally expressed by a Whewell equation (an intrinsic equation which expresses a curve in terms of its arc length and tangential angle), or by a Cesàro equation, which expresses a curve in terms of its arc length and radius of curvature (or equivalently, the curvature).

Limitations of such continuous interpolating curves as Bézier curves and B-splines A B-spline is a generalization of the Bézier curve (Bartels et al., 1998): B-splines with no internal knots are Bézier curves. A Bézier curve always passes through the first and last control points and lies within the convex hull of the control points. The ‘variation diminishing property’ of these curves is that no line can have more intersections with a Bézier curve than with the curve obtained by joining consecutive points with straight line segments.

Undesirable properties of Bézier (or Bernstein-Bézier) curves are their numerical instability for large numbers of control points, and the fact that moving a single control point changes the global shape of the curve. The former is sometimes avoided by smoothly patching together low-order Bézier curves.

Limited number of non-equivalent representations of a line object The methods of the existing art typically use only a limited number of non-equivalent representations of line objects, and fail to adequately represent different properties of these objects through different representations. For example, a typical representation of human handwriting acquired by a tablet device would be a parametric record of the Cartesian coordinates, where the parameter is a physical time. While such a record might adequately represent the kinematic properties of the line object, different objects with identical geometric properties are likely to have entirely different kinematic records and thus would require an alternative representation for comparison and/or identification with respect to geometric properties.

Lack of adequate tools for characterization of a line object ‘as a whole’ In their characterization of line objects, the approaches of the prior art tend to focus on a limited number of individual elements of these objects (for example, individual loops, arcs, characters, XR elements, etc.), and their linking and interrelations, without capturing the integral interrelations among various variables and parameters of different representations of line objects. These approaches fail to correctly compare and/or identify those line objects which are not adequately described in terms of such elements.

Limited number of non-equivalent distance measures of similarity of line objects and limited variety of non-equivalent metrics for line object comparison. Different variables of different representations are representative (reflective) of different features of a line object, and thus are relevant to different aspects of its characterization, identification, comparison, and analysis. In the existing art, the limitations in the number of alternative representations leads to the limitations in the number of variables describing a line object, and thus to the limitations in the number of available distance measures and metrics for line object comparison and/or identification.

Limitations of goodness-of-fit tests and other distance measures

Lack of adequate tools for management of line object databases

### DISCLOSURE OF INVENTION

### BRIEF SUMMARY OF THE INVENTION

The present invention overcomes the shortcomings of the prior art by providing:
Representations of line objects well suited for conditioning, modeling, characterization, identification, comparison, and analysis of such objects. These representations can be made invariant with respect to those properties of line objects which are not important and/or relevant for characterization, identification, and comparison of these objects; can be parameterized in such fashion that different variables of the representations are representative (reflective) of different features of the line objects, and thus are relevant to different aspects of characterization, identification, comparison, and analysis of these objects; are capable of capturing piecewise continuous nature of line objects, and are capable of using digitally sampled data for accurate treatment of segmentation, singularities, and irregular points of line objects.
Characterization of a line object in terms of the (modulated) distribution and/or density functions of the variables of a representation of said line object. These distribution/density functions capture interrelations among various parameters of different representations of a line object; allow construction of a large number of various non-equivalent distance measures of similarity of line objects, and large variety of non-equivalent metrics for their comparison and/or identification; provide the ability to characterize a line object ‘as a whole’, and focus on the features the most relevant for comparison and/or identification, disregarding the irrelevant features; provide the ability to characterize a line object in terms of the descriptive statistics of the respective modulated distribution and/or density functions, and provide the ability to determine the selectivity ranks of the distance measures and/or comparison metrics for a comparison and/or identification of the line objects.
Comparison and/or identification of line objects through various distance measures and goodness-of-fit tests of the distribution and/or density functions of different variables of the representations of the line objects. These distance measures and/or goodness-of-fit tests can be constructed in a manner which ensures that different comparison measures are non-equivalent; can be used in various combinations (for example, as a weighted sum with the weights dependent on the selectivity ranks of the distance measures and/or comparison metrics) for a comparison and/or identification decision.
Methods for construction of databases of line objects with self-learning capabilities for identification and/or comparison, including methods for adaptive selection of line objects from a database of line objects for comparison and/or identification with a sample line object; methods for adaptive ranking of the distance measures and/or comparison metrics based on the selectivity rank of the descriptive statistics of the respective modulated distributions and densities, and methods for making a comparison and/or identification decision based of the weights dependent on the selectivity ranks of the distance measures and/or comparison metrics.
Methods for conditioning and pre-processing of digitally sampled curves, including (i) methods for robust (coincidence) segmentation and (ii) methods for smoothing and/or interpolation of segmented curves in order index and/or other parameters.

Further scope of the applicability of the invention will be clarified through the detailed description given hereinafter. It should be understood, however, that the specific examples, while indicating preferred embodiments of the invention, are presented for illustration only. Various changes and modifications within the spirit and scope of the invention should become apparent to those skilled in the art from this detailed description. Furthermore, all the mathematical expressions and the examples of hardware implementations are used only as a descriptive language to convey the inventive ideas clearly, and are not limitative of the claimed invention.

### BRIEF DESCRIPTION OF FIGURES

FIG. 1 A simplified diagram of a typical system incorporating the present invention.

FIG. 2 Example of a line object.

FIG. 3 Examples of angular and linear distributions and their respective densities.

FIG. 4 Examples of comparison through two-sample statistics.

FIG. 5 Examples of a combined percentile comparison.

FIG. 6 Example of an entry in a database of line objects.

FIG. 7 Quadratic and cubic interpolating kernels.

FIG. 8 Interpolation of discontinuous and noisy data.

FIG. 9 Tangential interpolating curves constructed using quadratic (upper panels) and cubic (lower panels) kernels.

FIG. 10 Tangential (upper panel) and smoothing (lower panel) interpolations with a quadratic kernel.

FIG. 11 Defining the mean (or preferred) direction.

FIG. 12 Example of a curve aligned along the preferred direction defined by equation (45).

FIG. 13 Robust (coincidence) segmentation of a digitally-sampled curve.

FIG. 14 Screenshot of the upload module.

FIG. 15 Screenshot of the list module.

FIG. 16 Screenshot of the identification module.

FIG. 17 Original modulated linear densities of triangles with calculated principal axes and gyroradii.

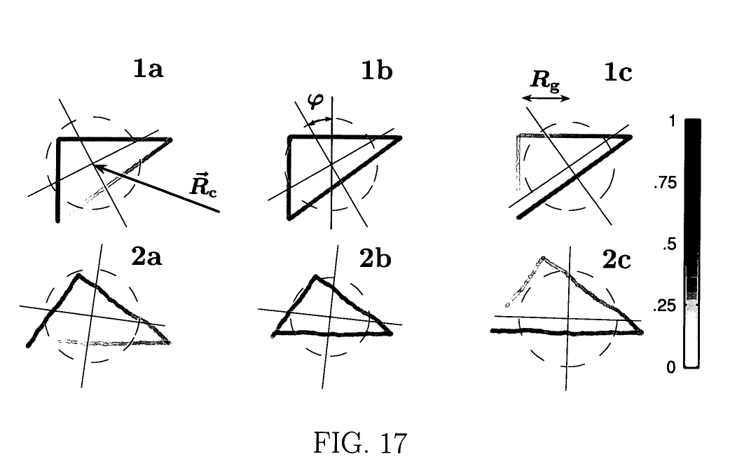

FIG. 18 Modulated linear densities of triangles after translation, rotation, and scaling.

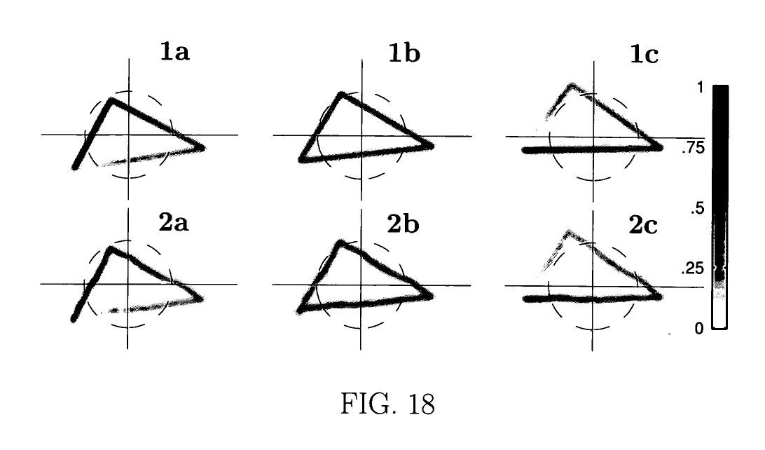

FIG. 19 Comparison of densities using statistic of Eq. (68).

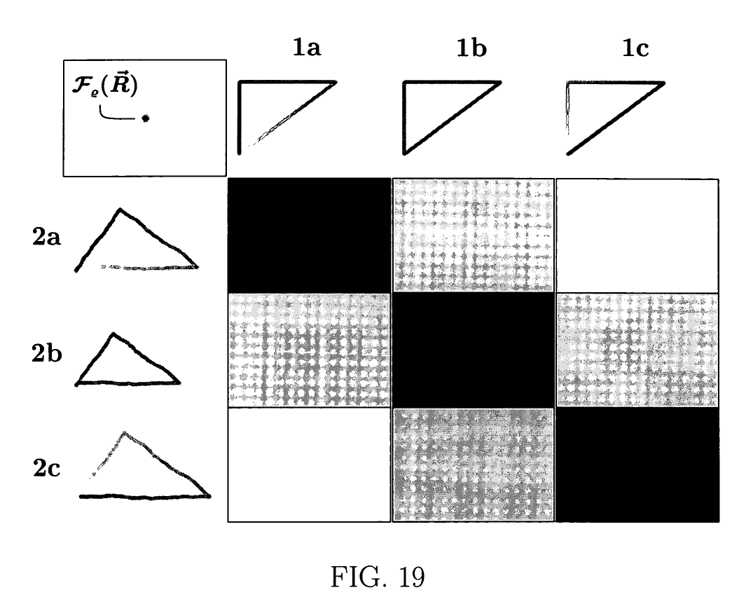

FIG. 20 Compromise between robustness and selectivity.

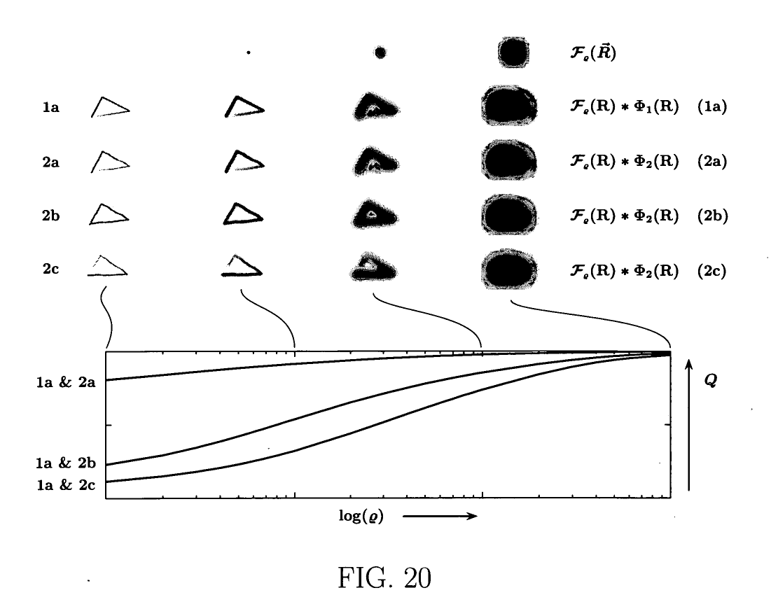

### DETAILED DESCRIPTION OF THE INVENTION

Note that in the detailed description of the invention the term ‘piecewise continuous representation (of a line object)’ shall mean ‘representation reflective of piecewise continuous nature (of a line object)’, even if said representation is expressed by its discrete (digital) record(s). Thus the term ‘continuous’ relates to an appropriate mathematical language describing the mathematical operations performed on the variables of said representation (such as, for example, differentiation and/or integration), even if the actual computations of such operations are conducted numerically (for example, in finite differences).

Also note that the detailed description of the invention provided below uses human handwritten signatures acquired by tablet devices as an example of line objects. One skilled in the art would recognize that this particular type of line objects is presented for illustration only, and other types of line objects can be treated in a similar manner. Also, it was assumed that such features of this particular type of line objects (human handwritten signatures) as (i) their position and orientation in space and (ii) their absolute dimensions are not important and/or relevant for their characterization, identification, and comparison. One skilled in the art would recognize that, for different types of line objects, these features may or may not be relevant for the respective purposes.

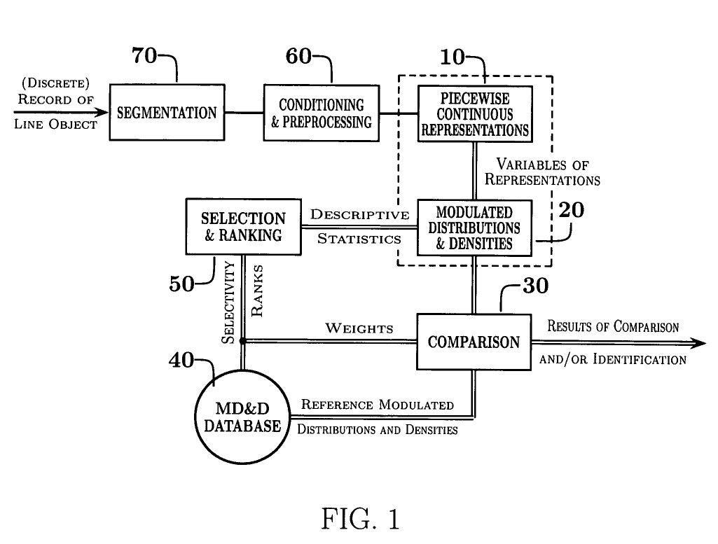

A simplified diagram illustrating the present invention is shown in FIG. 1. Step 10 is construction of a piecewise continuous representation, or a plurality of such representations, from a (discrete) record of a line object. The variables and parameters of these representations are used in Step 20, which constructs various modulated distribution and density functions of the variables of the representations created in Step 10. Step 20 may also output various descriptive statistics of the distributions created in this step for further use in Step 50. Step 30 uses the distribution and density functions created in Step 20 for comparison and/or identification of a line object by comparing the output(s) of Step 20 with a reference distribution through the use of goodness-of-fit tests or other distance measures. The reference distributions and/or densities are provided by Step 40, which composes various distributions and densities provided through Step 20 for a plurality of line objects into a database of such distributions and densities. For each line object, the database composed by Step 40 may contain, in addition to distributions and densities provided by Step 20, such entries as (i) the representations constructed in Step 10 and/or their variables, (ii) the descriptive statistics of the distributions provided by Step 20, (iii) the selectivity ranks of the distributions determined in Step 50, and (iv) the comparison and/or identification weights of the distributions determined in Step 50. Step 50 guides and optimizes the comparison and/or identification process of Step 30 by providing the intrinsic comparison and/or identification standards for the database composed in Step 40. These standards are established through computation of the selectivity ranks of different distributions and/or densities, and the selectivity ranks of different goodness-of-fit tests and other distance measures used in Step 30. Step 50 also provides the weights dependent on the selectivity ranks of the distance measures and/or comparison metrics for making comparison and/or identification decision in Step 30. The selectivity ranks of different distributions and/or densities, and the selectivity ranks of different goodness-of-fit tests and other distance measures are typically determined in Step 50 through comparison of measures of variance of different descriptive statistics and different goodness-of-fit tests computed for/among the database entries identified as identical or similar, with the respective measures of variance across the whole database or for/among the entries identified as dissimilar. Step 60 conducts smoothing and/or interpolation of a segmented curve in order index and/or other parameters, providing the ability to describe a line object given by its discrete (digital) record in terms of continuously varying variables. Step 70 implements robust (coincidence) segmentation of a line object presented by its discrete (digital) record, thus allowing the construction of piecewise continuous representations of said object.

The subsequent detailed description of the invention is organized as follows.

Section 1 (p. 11) describes constructing various representations of a curve invariant with respect to those properties which are not important and/or relevant for its characterization, identification, and comparison with other curves. This section also discusses the usage of different variables and parameters of the representations which are representative (reflective) of different features of the line objects, and thus are relevant to different aspects of characterization, identification, comparison, and analysis of these objects.

Section 2 (p. 16) describes characterization of a line object in terms of the distribution and/or density functions of the variables/parameters of a representation of the object.

Section (p. 21) discusses comparison and identification of line objects through goodness-of-fit tests and other measures of similarity of the distribution and/or density functions of the variables/parameters of representations of these objects.

Section 4 (p. 23) describes the databases of line objects and their distributions.

Section 5 (p. 24) discusses the optimization of the comparison and/or identification process through creation of intrinsic standards for the database.

Section 6 (p. 25) describes such elements of conditioning and preprocessing of line objects as tangential and smoothing interpolation in order index, and (optional) scaling and alignment along the preferred direction.

Section 7 (p. 29) describes a method arising from the formalism presented in § 1.3 for robust (coincidence) segmentation of a digitally sampled curve.

As an additional illustration of applications of the invention, § 8 (p. 31) provides outline of the signMine software package designed for performing signature identification and verification.

### 1 Representations of Line Objects

The first main step of the current invention is construction of a piecewise continuous representation, or a plurality of such representations, from a (discrete) record of a line object. These representations of a line object should be appropriate for conditioning, modeling, characterization, identification, comparison, and analysis of such an object. These representations: (i) can be made invariant with respect to those properties of line objects which are not important and/or relevant for characterization, identification, and comparison of these objects; (ii) can be parameterized in such fashion that different variables of the representations are representative (reflective) of different features of the line objects, and thus are relevant to different aspects of characterization, identification, comparison, and analysis of these objects; (iii) are capable of capturing piecewise continuous nature of line objects, and (iv) are capable of using digitally sampled data for accurate treatment of segmentation, singularities, and irregular points of line objects.

Note that the term ‘piecewise continuous representation (of a line object)’ shall mean ‘representation reflective of piecewise continuous nature (of a line object)’, even if said representation is expressed by its discrete (digital) record(s). Thus the term ‘continuous’ relates to an appropriate mathematical language describing the mathematical operations performed on the variables of said representation (such as, for example, differentiation and/or integration), even if the actual computations of such operations are conducted numerically (for example, in finite differences).

### 1.1 Example of a Line Object

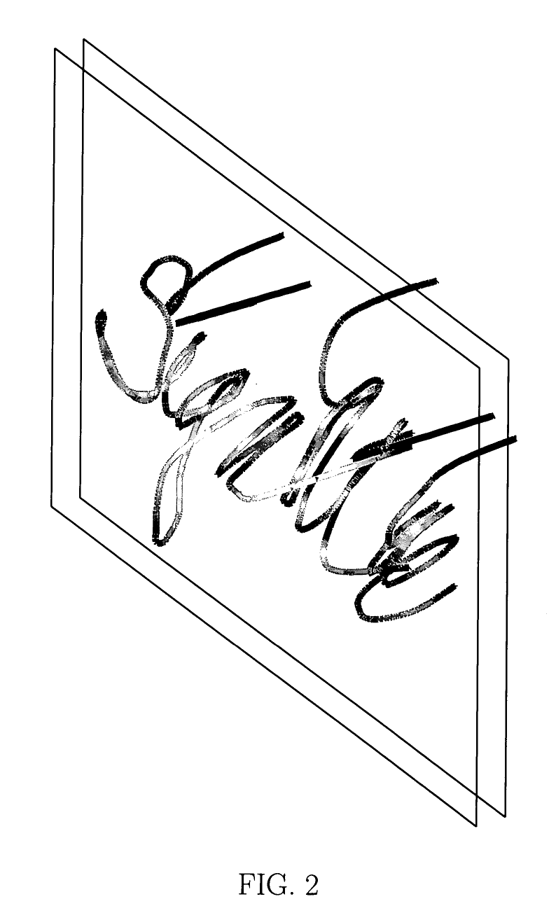

An example of a line object produced by human handwriting is provided in FIG. 2. This object is a piecewise continuous curve in the XY plane, and the Z coordinate is the force (‘pressure’) exerted along this curve by the tip of the writing utensil. The color of the line indicates the speed of the motion of the tip of the utensil (‘speed of writing’). In this example, the line object is represented by 4 variables (X and Y coordinates, force, and speed) which are functions of a parameter (physical time). Different representations can be derived by changing the coordinates and/or the parametrization of the object.

### 1.2 Intrinsic Form of a Curve

Consider a curve given in a parametric form ξ(o)=ξₓ(o)+iξ_{y}(o), where o is some continuous order parameter. It is convenient to call a representation of a curve ‘kinematic’ when the order parameter is a physical time t, ξ=ξ(t), and thus the curve can be interpreted as the trajectory of a moving particle. This trajectory can also be presented in a natural (or intrinsic) form, for example in terms of its arc length s and tangential angle φ(s) (Whewell equation), or in terms of its arc length s and curvature κ(s) (Cesàro equation). Such an intrinsic equation specifies the shape of a curve, independent of any choice of coordinates or parameterization (Yates, 1974), as a simple scalar function of one argument. If a curve were indeed representing a movement of a particle, the kinematics of this motion can be specified, for example, by providing the speed of the particle's motion along the curve, υ(t)=\dot{s}(t)=|\dot{ξ}(t)|.

The curvature and the arc length can be expressed as

$$κ ( t ) = \frac{𝒥 [ {\dot{ξ}}^{*} ( t ) \ddot{ξ} ( t ) ]}{{\vert \dot{ξ} ( t ) \vert}^{3}} , and s ( t ) = {\int }_{0}^{t} ⅆ {t}^{′} \vert \dot{ξ} ( {t}^{′} ) \vert , \qquad ( 1 )$$

where z* denotes the complex conjugate of z, and ℑ[z] is the imaginary part of z. The curve itself then can be expressed as

$$ξ ( s ) = {ξ}_{0} + {\int }_{0}^{s} ⅆ {s}^{′} {ⅇ}^{ⅈ φ ( {s}^{′} )} , \qquad ( 2 )$$

where the tangential angle φ is

$$φ ( s ) = {φ}_{0} + {\int }_{0}^{s} ⅆ {s}^{′} κ ( {s}^{′} ) . \qquad ( 3 )$$

Note that equation (1) is valid only for differentiable and regular curves as it requires finite and nonvanishing speed |\dot{ξ}(t)|. This restriction makes equation (1) unsuitable for description such irregular and discontinuous curves as those representing human handwriting, and renders this equation virtually useless when those curves are given as discrete (digital) records. In the current disclosure, we describe a method which enables accurate representation, in terms a natural equation of the underlying continuous curve, of a modulated curve given by a discrete sets of ordered data. Further, we demonstrate how such a representation leads to a set of tools for conditioning, analysis, comparison, and identification of line objects, including human handwritten signatures, and provide an outline of the SIGNMINE software package.

### 1.3 Description of a Piecewise Continuous (Segmented) Curve

A curve z =x +iy resulting, for example, from human handwriting (such as, for example, a signature) can consist of only one contiguous component, or a plurality of components. In the latter case, the order and relative positions of the components might be relevant to verification and/or identification of the curve. When the components are arranged in ‘chronological’ order (e.g., using an order parameter o, 0 ≦o ≦1), we can preserve the information about their order and relative positions by connecting the ends of the ‘earlier’ components with the respective origins of the ‘later’ components by straight-line segments. In our description of a curve, we want the ability to easily switch between the two representations of the curve, including or excluding the connecting segments, while preserving a unified formalism. We shall use the term ‘connected segmented curve’ when the straight-line segments are included, and the term ‘disconnected curve’ otherwise.

Differential displacement along a connected segmented curve can be formally defined as

$$ⅆ l = \vert \frac{ⅆ}{ⅆ o} z ( o ) \vert ⅆ o , \qquad ( 4 )$$

where it is assumed that the derivatives at discontinuities of z(o) can be expressed using the Dirac δ-function (see Dirac, 1958, for example).

Differential displacement along a disconnected curve is defined as

$$\begin{matrix}ⅆ s = \vert \frac{\overline{ⅆ}}{ⅆ o} z ( o ) \vert ⅆ o , \\ where & ( 5 ) \\ \frac{\overline{ⅆ}}{ⅆ o} z ( o ) = \frac{1}{2} ( \frac{ⅆ}{ⅆ o +} + \frac{ⅆ}{ⅆ o -} ) z ( o ) , & ( 6 )\end{matrix}$$

$$and \frac{ⅆ z}{ⅆ o +} and \frac{ⅆ z}{ⅆ o -} \qquad ( 7 )$$

are the right-hand and left-hand, respectively, derivatives of z:

$$\frac{ⅆ}{ⅆ o \pm } z ( o ) = {lim}_{ɛ -> 0} \frac{z ( o \pm ɛ ) - z ( o )}{\pm ɛ} .$$

It should be easy to see from equations (4) and (5) that dl and ds are related as

$$\begin{matrix}ⅆ l = ⅆ s + δ l ( o ) = ⅆ s + δ l ( s ) , \\ where & ( 8 ) \\ δ l ( x ) = {lim}_{ɛ -> 0} \vert z ( x + ɛ ) - z ( x - ɛ ) \vert , & ( 9 )\end{matrix}$$

Note that dl≡ds anywhere within a continuous component of the curve.

The total lengths of a disconnected and a connected segmented curves, respectively, can be expressed as

$$S = {\int }_{0}^{1} ⅆ o \frac{ⅆ s}{ⅆ o} , L = {\int }_{0}^{1} ⅆ o \frac{ⅆ l}{ⅆ o} = S + {\sum }_{i} δ l ( {s}_{i} ) , \qquad ( 10 )$$

where the summation goes over all points sᵢ where the curve is discontinuous.

### 1.4 Intrinsic Equation for a Piecewise Continuous Curve

When the tangential angle is expressed as

$$ϕ ( s ) = {lim}_{ɛ -> 0} arg [ z ( s + ɛ ) - z ( s - ɛ ) ] , \qquad ( 11 )$$

where arg(z) is the (complex) argument of a complex number z (see § below), an intrinsic (Whewell) equation of a piecewise continuous curve can be written as

$$z ( s ) = {\int }_{0}^{s} ⅆ {s}^{′} {ⅇ}^{ⅈ ϕ ( {s}^{′} )} + {\sum }_{i} δ l ( {s}_{i} ) {ⅇ}^{ⅈ ϕ ( {s}_{i} )} θ ( s - {s}_{i} ) , \qquad ( 12 )$$

where θ(x) is the Heaviside unit step function, and the summation goes over all points sᵢ where the curve is discontinuous.

The kinematic description is obtained by expressing the arc length and the tangential angle as functions of time,

$$z ( t ) = {\int }_{0}^{t} ⅆ {t}^{′} \dot{s} ( {t}^{′} ) {ⅇ}^{ⅈ ϕ ( {t}^{′} )} + {\sum }_{i} δ l ( {t}_{i} ) {ⅇ}^{ⅈ ϕ ( {t}_{i} )} θ ( t - {t}_{i} ) , \qquad ( 13 )$$

where the dot over s denotes a time derivative.

### 1.4.1 Quadrant-specific Inverse Tangent

The (complex) argument of a complex number z can be computed as a quadrant-specific arctangent and defined as follows:

$$arg ( z ) = arg ( x + iy ) = \{ \begin{matrix}arcsin ( y / \vert z \vert ) & if & x \geq 0 \\ - arcsin ( y / \vert z \vert ) + π & if & x < 0 , y \geq 0 \\ - arcsin ( y / \vert z \vert ) - π & if & x < 0 , y < 0 \\ 0 & if & \vert z \vert = 0\end{matrix} . \qquad ( 14 )$$

### 1.5 Other Representations

One skilled in the art would recognize that the representations of curves described above can be easily modified by changing their variables (for example, by using order, arc length, or time as parameters) in such fashion that these are reflective of different features of the line objects (for example, kinematic or geometric), and thus are relevant to different aspects of characterization, identification, comparison, and analysis of these objects. By changing the variables of the representations, we can make the latter invariant with respect to those properties of line objects which are not important and/or relevant for characterization, identification, and comparison of these objects, and focus on the different features of the objects. For example, we can separate geometric properties of a line object from its kinematic properties, consider or disregard the order and connectivity of contiguous components of the object, etc. Additional examples of the representations of line objects are provided in § 6.4.

### 2 Characterization of a Line Object in Terms of the Distribution and/or Density Functions of the Variables/Parameters of a Representation of the Object

The line objects can be characterized in terms of various modulated distribution and/or density functions of the variables of their representations (Nikitin and Davidchack, 2003a,b). Depending on the nature of said variables, these distribution functions can take various forms such as, for example, angular (circular) distributions and densities (e.g., offset distributions) for cyclic variables, or linear distributions and densities, and capture different interrelations among various variables of different representations of a line object. By changing the modulation in the distributions (see Nikitin and Davidchack, 2003a,b, for example), the distributions can be made reflective of different interrelations among the variables and/or parameters, e.g. geometric and/or kinematic. The modulated distribution and density functions allow construction of a large number of various non-equivalent distance measures of similarity of line objects, and large variety of non-equivalent metrics for their comparison and/or identification. Said distributions also provide the ability to characterize a line object ‘as a whole’, and focus on the features the most relevant for comparison and/or identification, disregarding the irrelevant features, and provide the ability to characterize a line object in terms of the descriptive statistics of the respective modulated distribution and/or density functions, allowing to determine the selectivity ranks of the distance measures and/or comparison metrics for a comparison and/or identification of the line objects.

### 2.1 Circular (Angular) Distributions and the Respective Densities

The amplitude distribution of an angular (or cyclic with the modulus 2π) variable φ=φ(s) can be computed as

$${Ψ}_{s} ( β ) = \frac{1}{S} {\int }_{0}^{S} ⅆ s θ [ β - φ ( s ) ] , \qquad ( 15 )$$

where we can take, without loss of generality, the range of φ(s) to be from −π to π. The distribution function Ψₛ(β) can be given the following probabilistic interpretation: if s is a uniform deviate in a range 0 to S, then Ψₛ(β) is the probability that φ(s) does not exceed β.

In practice, the amplitude distribution Ψₛ(β) can be computed as (see Nikitin and Davidchack, 2003a,b, for example)

$${Ψ}_{s} ( β ) = \frac{1}{S} {\int }_{0}^{S} ⅆ s {ℱ}_{Δ D } [ β - φ ( s ) ] , \qquad ( 16 )$$

where [symbol] _{ΔD}(x) is a continuous function which changes monotonically from 0 to 1 so that most of this change occurs over some characteristic range of threshold values Δ, and

$${lim}_{Δ -> 0} {ℱ}_{Δ D } ( x ) = θ ( x ) . \qquad ( 17 )$$

The respective density is a periodic function

$${ψ}_{s} ( β ) = \frac{ⅆ}{ⅆ β} {Ψ}_{s}^{*} ( β ) = {ψ}_{s} ( β + 2 π k ) , \qquad ( 18 )$$

where Ψ*ₛ(β) is defined as
Ψ*ₛ(β)=Ψₛ(β+2πk)−k,
−π(2k+1)<β≦−π(2k−1), (19)
and k is an integer.

### 2.1.1 Examples of Angular Distributions

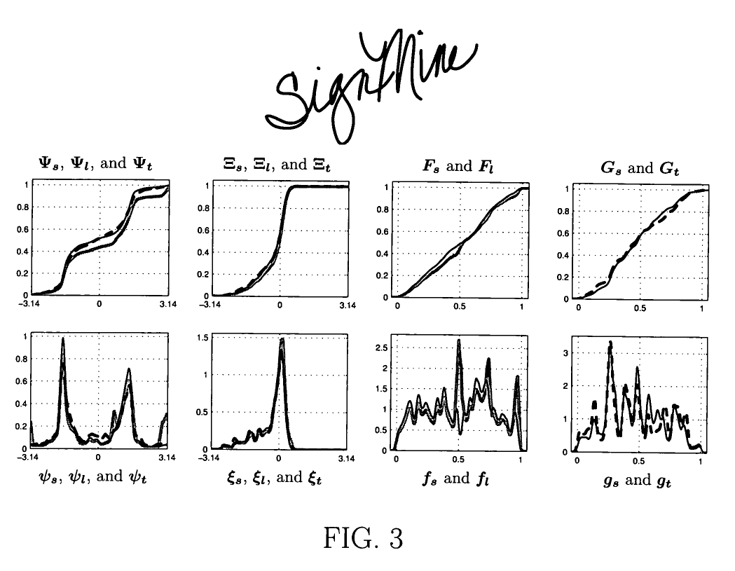

Several examples of angular distributions can be given as follows:

$$\begin{matrix}{Ψ}_{s} ( β ) = \frac{1}{S} {\int }_{0}^{S} ⅆ s θ [ β - φ ( s ) ] , & ( 20 ) \\ {Ψ}_{l} ( β ) = \frac{1}{L} {\int }_{0}^{L} ⅆ l θ [ β - φ ( l ) ] , & ( 21 ) \\ {Ψ}_{t} ( β ) = \frac{1}{T} {\int }_{0}^{T} ⅆ t θ [ β - φ ( t ) ] , & ( 22 )\end{matrix}$$

where φ is the tangential angle, and

$$\begin{matrix}{Ξ}_{s} ( β ) = \frac{1}{S} {\int }_{0}^{S} ⅆ s θ [ β - α ( s ) ] , & ( 23 ) \\ {Ξ}_{l} ( β ) = \frac{1}{L} {\int }_{0}^{L} ⅆ l θ [ β - α ( l ) ] , & ( 24 ) \\ {Ξ}_{s} ( β ) = \frac{1}{T} {\int }_{0}^{T} ⅆ t θ [ β - α ( t ) ] , & ( 25 )\end{matrix}$$

where α is the polar angle of equation (44). Note that equations (20), (21), (23), and (24) relate to the geometric description of a curve, while equations (22) and (25) relate to its kinematic description. FIG. 3 shows the distributions, along with their respective densities, given by equations (20) through (25) in the left-half panels. Ψₛ, ψₛ, Ξₛand ξₛ , are shown by the solid black lines, Ψₗ, and ξₗ are shown by the gray lines, and Ψₜ, ψₜ, Ξₜ, and ξₜ are plotted by the dashed black lines.

### 2.2 Linear Distributions and the Respective Densities

Various linear distributions and the respective densities of a variable x=x(s) can be viewed as different appearances of general modulated distributions

$$\begin{matrix}Φ ( D ) = \frac{{\int }_{0}^{S} ⅆ s K ( s ) {ℱ}_{Δ D } [ D - x ( s ) ]}{{\int }_{0}^{S} ⅆ s K ( s )} & ( 26 ) \\ ϕ ( D ) = \frac{ⅆ Φ ( D )}{ⅆ ( D )} = \frac{{\int }_{0}^{S} ⅆ s K ( s ) {f}_{Δ D } [ D - x ( s ) ]}{{\int }_{0}^{S} ⅆ s K ( s )} , & ( 27 )\end{matrix}$$

and densities
where K(s) is a unipolar modulating signal (see Nikitin and Davidchack, 2003b, for example), and f_{ΔD}(x)=d [symbol] _{ΔD}(x)/dx. Various choices of the modulating signal allow us to introduce different types of threshold densities and impose different conditions on these densities.

### 2.2.1 Examples of Linear Distributions

Several examples of linear distributions can be given as follows:

$$\begin{matrix}{F}_{s} ( \frac{t}{T} ) = \frac{s ( t )}{S} , \\ {F}_{l} ( \frac{t}{T} ) = \frac{l ( t )}{L} , \\ {G}_{s} ( χ ) = \frac{1}{S} {\int }_{0}^{S} ⅆ s θ [ χ - \frac{r ( s )}{{r}_{max}} ] , and \\ {G}_{t} ( χ ) = \frac{1}{T} {\int }_{0}^{T} ⅆ t θ [ χ - \frac{r ( t )}{{r}_{max}} ] .\end{matrix} \qquad ( 28 )$$

FIG. 3 shows the distributions, along with their respective densities, given by equation (28). Fₛ, fₛ, Gₛ, and gₛ are shown by the solid black lines, Fₗ, and fₗ are shown by the gray lines, and Gₜ and gₜ are shown by the dashed black lines.

Note that the interpolation scheme described in § 6.1 allows easy numerical computation of the densities from known distributions.

### 2.3 Descriptive Statistics

For comparison and/or identification of line objects, we can introduce many ‘direct’ comparison measures for the distribution and density functions, such as the ‘distance’ estimates, etc. However, most of those measures would have a computational complexity in O(N²). This is appropriate for comparison and/or verification, but is not suitable for identification and search.

Even though different forms of expressing a curve may be equivalent, various distributions constructed for different variables may be different in terms of their ‘descriptive’ ability, and have different robustness and selectivity with respect to different variations in the curve (e.g., due to noise, discontinuities, singular and/or improper points, etc.). Given a variety of distributions of the variables expressing a line object, we can also introduce a large number of descriptive statistics for those distributions, such as moments of linear distributions, trigonometric moments for circular distributions, various entropy-based statistics, and other. We can then characterize the curve in terms of those statistics and/or distributions. This allows us to reduce both the size of the inputs (by an order of magnitude or more) and the computational complexity of comparison (to O(N) or even O(logN)). It also enables a ‘hierarchical’ organization of search and retrieval.

### 2.3.1 Basis for entropy-based statistics

We can define the entropy [symbol] for a density function φ(x) as

$$ℋ = {C}_{f} - {\int }_{- ∞}^{∞} ⅆ x φ ( x ) ln [ \frac{φ ( x )}{{f}_{Δ D} ( 0 )} ] \geq 0 , \qquad ( 29 )$$

where f_{ΔD}(O) is the modal value of f_{ΔD}(X)=dF_{ΔD}(x)/dx, and C_{f} is a normalization constant which is a property of the probe f_{ΔD},

$${C}_{f} = {\int }_{- ∞}^{∞} ⅆ α {f}_{Δ D} ( α ) ln [ \frac{{f}_{Δ D} ( α ) }{{f}_{Δ D} ( 0 )} ] \leq 0 , \qquad ( 30 )$$

dependent only on the shape of f_{ΔD}. One skilled in the art would recognize that a variety of alternative definitions of the entropy can be used for the entropy-based statistics.

### 3 Comparison and Identification Through Goodness-of-fit Tests and Other Distance Measures

Note that even though the properties of the threshold distributions and densities defined above are usually associated with those of the probability distributions and densities, the above definitions are given for deterministic signals and do not rely on the usual axioms of probability and statistics. The formal similarity of the latter with the probability functions, however, allows us to explore probabilistic analogies and interpretations. Such interpretations enable the construction of a variety of ‘statistical’ estimators to evaluate the similarity between a pair of variables in a flexible way, permitting a meaningful adaptation to particular problems (see Nikitin and Davidchack, 2003a,b, for example).

### 3.1 Goodness-of-fit Tests for Linear Distributions

As a measure of discrepancy between two distributions, one can use such statistics as Kolmogorov-Smirnov and Cramér-von Mises (see Darling, 1957; Kac et al., 1955, for example).

### 3.1.1 Two-sample Cramér-von Mises Statistic

For two linear distributions F and G, the following statistic of Cramér-von Mises type (see Darling, 1957; Kac et al., 1955, for example) can be used:

$${γ}^{2} ( F , G ) = \frac{3}{2} {\int }_{- ∞}^{∞} ⅆ [ F ( x ) + G ( x ) ] {W [ F ( x ) + G ( x ) ] [ F ( x ) - G ( x ) ]}^{2} , \qquad ( 31 )$$

where W is a (normalized) weight function and, if both F and G are continuous, the integration may be carried out with respect to either 2F or 2G instead of F+G, since

$${\int }_{- ∞}^{∞} ⅆ {[ F ( x ) - G ( x ) ] [ F ( x ) - G ( x ) ]}^{2} = 0. \qquad ( 32 )$$

### 3.2 Goodness-of-fit Tests for Circular Distributions

For circular distributions, one can use the circular-invariant modifications of the Kolmogorov-Smirnov and Cramér-von Mises tests (see Darling, 1957, for example), such as the Kuiper (Kuiper, 1962) and Watson (Watson, 1961) statistics.

### 3.2.1 Two-sample Watson Statistic

Two-sample Watson statistic w², 0 ≦w²≦1, can be defined as
w²(Ψ₁, Ψ₂)=6∫_{-π}^{π}dβψ₁₂(β)W[Ψ₁(β)+Ψ₂(β)][Ψ₁(β)−Ψ₂(β)]²−\overline{ΔΨ}₁₂², (33)
where W is a (normalized) weight function, ψ₁₂=ψ₁+ψ₂, and
\overline{ΔΨ}₁₂=\sqrt{3}∫_{-π}^{π}dβψ₁₂(β)W[Ψ₁(β)+Ψ₂(β)][Ψ₁(β)−Ψ₂(β)]. (34)

### 3.3 Other Comparison Tests

One skilled in the art would recognize that, in addition to the two-distribution statistics described above, one can employ a variety of other goodness-of-fit and distance measures for the distribution and/or density functions, such as different correlation and entropy-based tests (for example, the differential entropy). These distance measures and/or goodness-of-fit tests can be constructed in a manner which ensures that different comparison measures are non-equivalent, and can be used in various combinations (for example, as a weighted sum with the weights dependent on the selectivity ranks of the distance measures and/or comparison metrics) for a comparison and/or identification decision.

### 3.4 Percentile Comparison for Identification and/or Comparison

If qᵢⱼ is the statistic resulting from a similarity (goodness-of-fit) test between i th and j th distributions, then the similarity score assigned to this value can be calculated as, for example,

$${P}_{ij} = P ( {q}_{ij} ) = \frac{1}{{N}^{2}} {\sum }_{k = 1}^{N} {\sum }_{l = 1}^{N} θ ( {q}_{kl} - {q}_{ij} ) , \qquad ( 35 )$$

where the summation is carried out over all distributions, and can be interpreted as the probability to find a worse match between all available pairs of distributions. It is assumed in equation (35) that the statistic qᵢⱼ is a non-increasing measure of similarity.

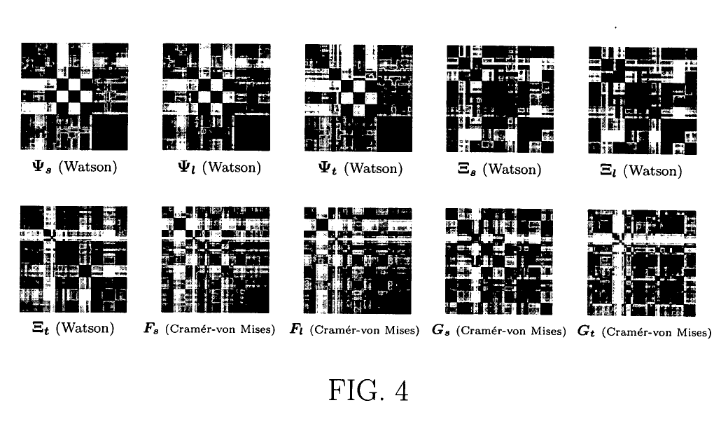

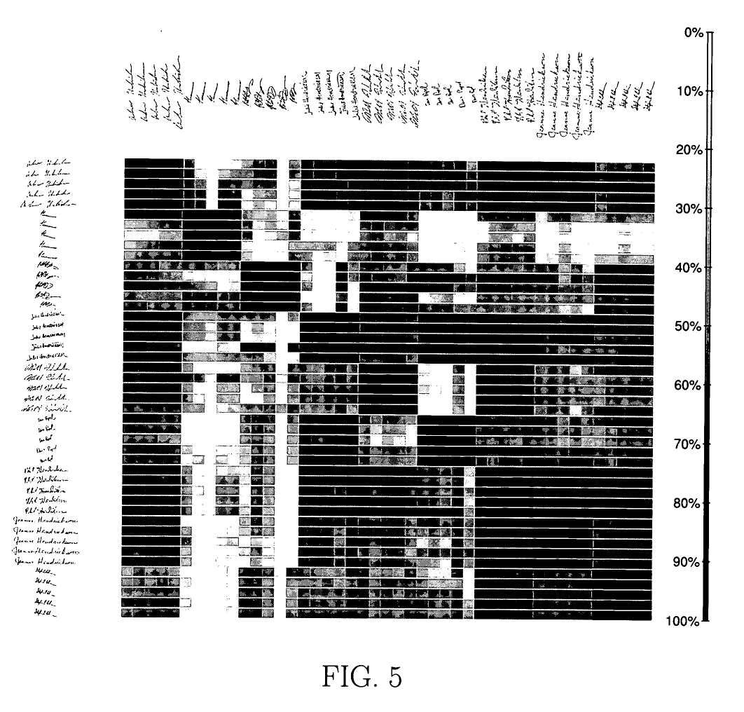

FIG. 4 provides an example of the matrices Pᵢⱼ constructed for various distributions described in § 2. Here, a sample of 45 signatures taken from 9 persons (5 signatures per person) was used. Notice that signatures taken from the same person consistently exhibit high level of similarity (5-by-5 blocks along the diagonals of the matrices) regardless the type of the distribution, while the measures of similarity of the signatures taken from different persons vary in a wide range, depending on the distribution used. Thus the total percentile comparison matrix \overline{P}ᵢⱼ can be constructed as a measure of central tendency of the elements Pᵢⱼ calculated for different types of distributions, and the ‘reliability’ of this estimate can be calculated as the respective measure of dispersion. FIG. 5 provides an example of such a matrix \overline{P}ᵢⱼ calculated for the comparison matrices depicted in FIG. 4.

### 4 Databases of Line Objects and their Distributions and Densities

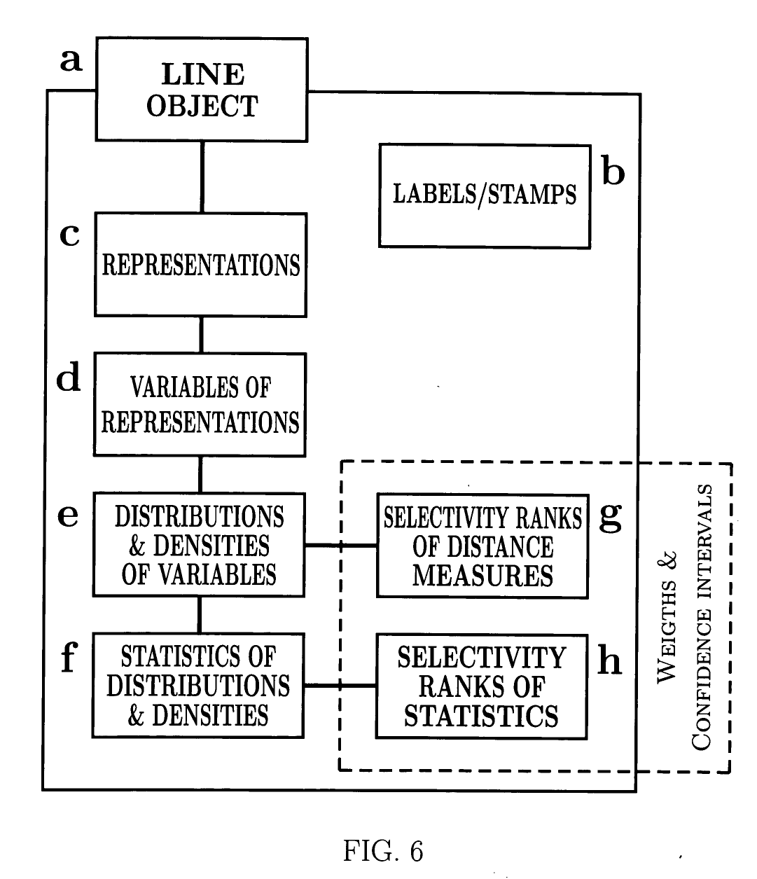

Various distribution and density functions computed for different variables of the representations of a plurality of line objects are composed into a database. For each line object, such a database may contain, in addition to distributions and densities, such entries as (i) various representations of the line objects and/or their variables, (ii) the descriptive statistics of the distributions, (iii) the selectivity ranks of the distributions, and (iv) the comparison and/or identification weights and confidence intervals of comparison and/or identification. The database should also include a means for updating the selectivity ranks with the addition of new entries, and a means of recalculating the weights and the confidence intervals. An example of an entry in a database of line objects is shown in FIG. 6.

While the selectivity weights enhance the reliability of a comparison and/or identification decision, the confidence intervals increase the speed of the database search and/or the decision making. An example of the usage of a confidence interval of a descriptive statistic for identification of a line object is as follows: If the respective statistic falls within the confidence interval, the database entry is retained for the subsequent processing. Otherwise, the entry is excluded from consideration.

### 5 Selection and Ranking

The process of comparison and/or identification of line objects is guided and optimized by providing the intrinsic comparison and/or identification standards for the database. These standards are established through computation of the selectivity ranks of different distributions and/or densities, and the selectivity ranks of different goodness-of-fit tests and other distance measures.

The selectivity ranks of different distributions and/or densities, and the selectivity ranks of different goodness-of-fit tests and other distance measures are typically determined through comparison of measures of variance of different descriptive statistics and different goodness-of-fit tests computed for/among the database entries identified as identical or similar, with the respective measures of variance across the whole database or for/among the entries identified as dissimilar. If, for example, the ratio of the deviation (e.g., standard or absolute deviation) of a certain statistic (e.g., some moment of some linear distribution) within the groups of similar entries (e.g., signatures of the same persons) to the deviation of this statistic across the entire database is small, this statistic is assigned a high selectivity rank and a large weight. Otherwise, this statistic receives a low selectivity rating and a small weight.

### 6 Conditioning and Preprocessing

Conditioning and pre-processing of digitally sampled line objects would typically include (i) robust (coincidence) segmentation and (ii) smoothing and/or interpolation of segmented curves in order index and/or other parameters. Smoothing and/or interpolation of a segmented curve in order index and/or other parameters provides the ability to describe a line object given by its discrete (digital) record in terms of continuously varying parameters. Robust (coincidence) segmentation of a line object presented by its discrete (digital) record allows the construction of piecewise continuous representations of said object.

### 6.1 Interpolation in Order Index

Consider a (raw) digital record which consists of the sets of the Cartesian coordinates {rᵢ}={xᵢ, yᵢ}, the time values {tᵢ}, and the (optional) modulation {fᵢ}, where i=0, 1, 2, . . . , N is an order index. It is convenient to use a normalized order index o, 0≦o=iN⁻¹≦1, instead of an integer i. The modulation vector f can be, for example, the force (pressure) applied by the writing utensil, the curve's color, etc. The main purpose of (smoothing) interpolation is to (re-)create a continuous representation of a curve from its digital record. This continuous representation must adequately correspond to the raw digital record, and should be suitable for expression in an intrinsic form. When such a continuous (high resolution) record is available, all parameter values along the interpolating curve (the values of the Cartesian coordinates, arc length, tangential angle, curvature, time, speed, modulation, etc.) can be obtained with arbitrary precision. In addition, interpolation allows the reduction of noise and sensitivity to the size of sampling interval(s).

The simplest interpolation is a linear (broken-line) interpolation, which amounts to connecting the sequential points rᵢ and rᵢ₊₁ by straight-line segments and corresponding definition of the values of the other parameters (e.g., the speed and the tangential angle) along those segments. Even though a broken-line curve is not differentiable (and thus, for example, the curvature is zero anywhere between vertices and is infinite at a vertex joining a pair of non-parallel segments), a proper handling of singularities allow its intrinsic-form description, as illustrated in § 1.4.

In a case of noisy finely-sampled data, representation of a (piecewise) smooth curve through a broken-line interpolation is misleading and virtually useless. The main usage of the linear interpolation is as follows: (i) obtain the vertices (their coordinates as well as other parameters at those points) by sampling the piecewise smooth tangential or smoothing interpolating curve, then (ii) use the linear broken-line representation to obtain the necessary descriptive parameters of the curve suitable for numerical calculations.

### 6.2 ‘Tangential’ Interpolation by a Finite-size Continuous Kernel

Given a discrete (ordered) set of reference points (xᵢ, yᵢ), i=0, 1, 2, . . . , N, where xᵢ are the arguments of the reference points, and yᵢ are the values of the reference points, the values of a function y(x) and its various derivatives (of nth order) at arbitrary x can be determined through the following interpolation scheme:

$$\frac{{ⅆ}^{n}}{ⅆ {x}^{n}} [ y ( x ) - {y}_{0} ] = {\sum }_{i = 0}^{N - 1} Δ {y}_{i} \frac{{ⅆ}^{n}}{ⅆ {x}^{n}} \frac{{H}_{Δ} ( x - {x}_{i} ) - {H}_{Δ} ( x - {x}_{i + 1} )}{Δ {x}_{i}} , \qquad ( 36 )$$

where the increments in the arguments and the values of the reference points, respectively, are Δxᵢ=xᵢ₊₁−xᵢ and Δyᵢ=yᵢ₊₁−yᵢ, the ratio of the reference increment in the kernel to the increment in the arguments of the reference points is

$$\frac{{H}_{Δ} ( x - {x}_{i} ) - {H}_{Δ} ( x - {x}_{i + 1} )}{Δ {x}_{i}} = \frac{ⅆ}{ⅆ x} {H}_{Δ} ( x - {x}_{i} ) if Δ {x}_{i} = 0 , \qquad ( 37 )$$

and H_{Δ}(x) is a continuous (differentiable) kernel having a width parameter Δ such that in the limit lim Δ→0 said kernel becomes a ramp function,

$${lim}_{Δ -> 0} {H}_{Δ} ( x ) = x θ ( x ) . \qquad ( 38 )$$

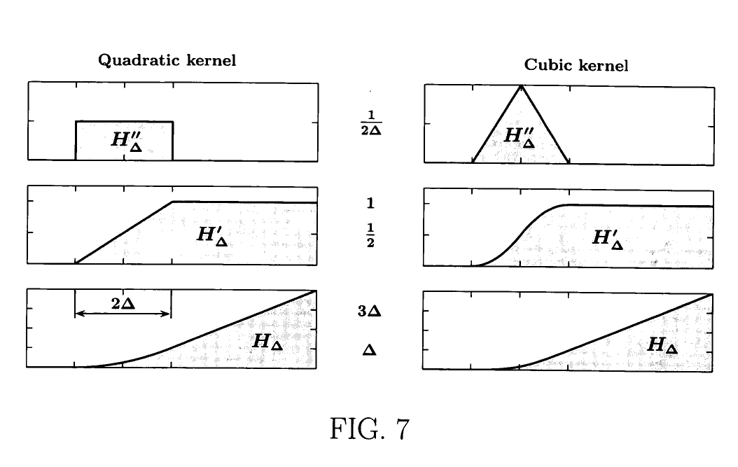

Also note that, as follows from equation (38), lim_{Δ→0}H′_{Δ}(x)=θ(x), and lim_{Δ→0}H″_{Δ}(x)=δ(x), etc., and in the limit Δ→0, for Δxᵢ>0, equation (36) represents a simple linear interpolation. FIG. 7 shows the quadratic and cubic interpolating kernels.

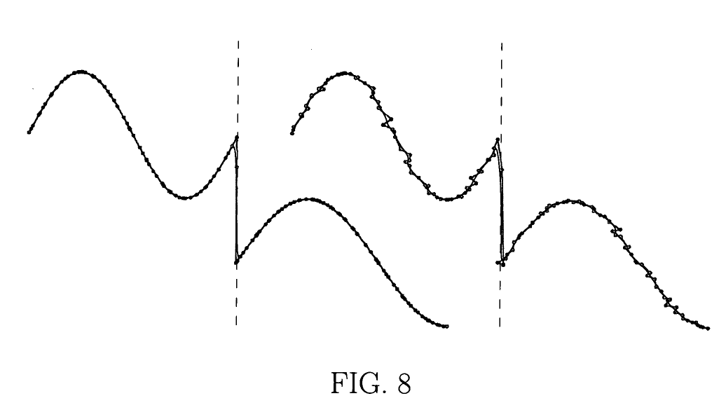

Notice that the interpolation scheme given by equation (36) can handle discontinuous data (i.e., Δxᵢ=0), and does not require {xᵢ} to be monotonic (i.e., Δxᵢ can be negative). Thus it is suitable for interpolating discontinuous and noisy data, as illustrated in FIG. 8.

If the width of a kernel does not exceed half of the increment in the original order index (i.e., Δo≦(2N)⁻¹), interpolation leads to a smooth curve with the following properties:
the interpolating curve passes through a middle point of each straight-line segment connecting a pair of adjacent vertices while being tangential to the respective segment at this point, and
the tangential angle to the interpolating curve changes monotonically between the middles of any two adjacent segments of the broken line.

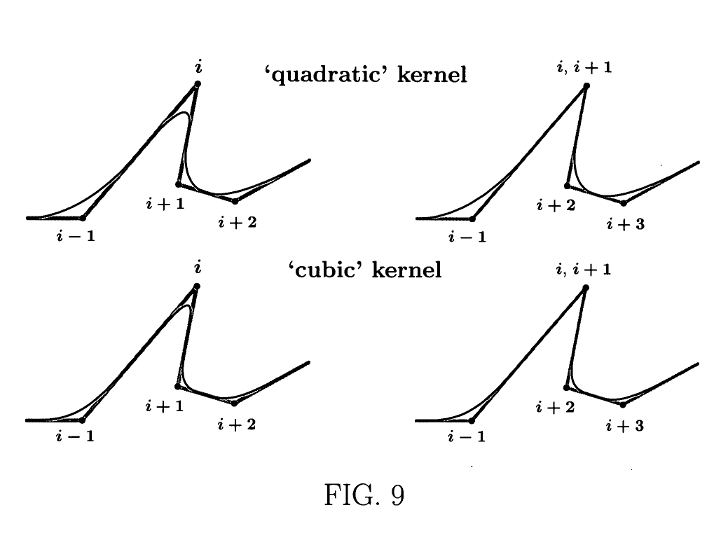

This is illustrated in FIG. 9 for interpolations using quadratic (upper panels) and cubic kernel (lower panels). Notice that in the righthand panels the vertices i and i+1 coincide forming a single vertex, and that the interpolating curve passes through this vertex.

A typical use of a tangential interpolation would be in a case when accuracy of data acquisition is achieved at the expense of the increase in the sampling interval(s), which leads to a too ‘rugged’ shape of a curve when a linear interpolation is used.

### 6.3 Smoothing Interpolation

In a smoothing interpolation, the width of a kernel exceeds half of the increment in the original order index (i.e., Δo>(2N)⁻¹), and thus, as described in § 6.2, the values of the interpolating curve result from a contribution of more than a single original data point. A typical use of a smoothing interpolation is the reduction of noise when the increase in sampling frequency leads to the loss of accuracy in data acquisition.

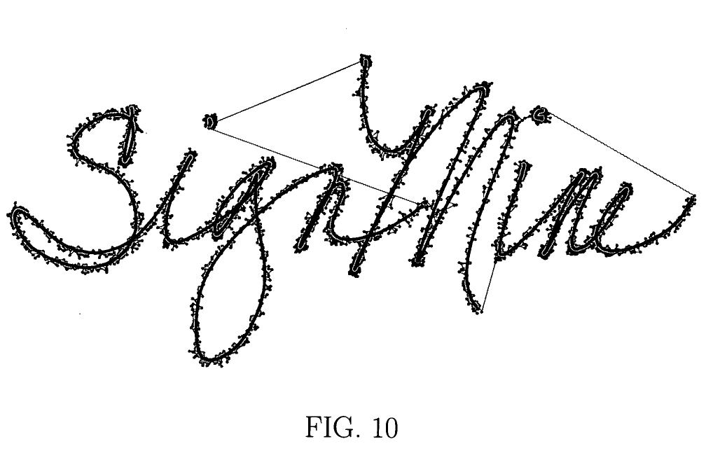

FIG. 10 illustrates both tangential (upper panel) and smoothing (lower panel) interpolations with a quadratic kernel. In both panels, the raw data is shown in grey (in a form of linear broken-line interpolations), and the interpolating curves are shown by black lines.

### 6.4 Scaling and Alignment Along the Preferred Direction

There are many alternative definitions of such factors as the size (total arc length), orientation, and position of a curve in relation to the coordinates' origin (see Nikitin and Popel, 2004a, for example). For example, the definitions of the center of a curve and its mean (or preferred) direction can be defined in kinematic and/or geometric sense, and will depend on whether the connecting (discontinuous) segments are included into consideration. It may be argued that such factors by themselves are not relevant to the curve's verification and/or identification, even though the differences in these factors due to different definitions may serve as descriptive statistics.

The mean (or preferred) direction, \overline{φ}, can be defined in a variety of ways. For example, for a disconnected curve it can be computed in geometric sense as

$$\overline{ϕ} = {\overline{ϕ}}_{s} = arg ( {\int }_{0}^{S} ⅆ {sⅇ}^{ⅈϕ ( s )} ) , \qquad ( 39 )$$

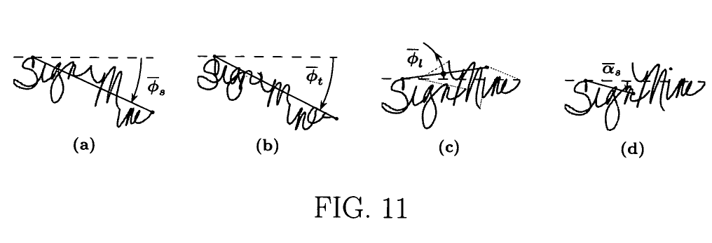

and its geometric meaning, as illustrated in FIG. 11 (a), is the direction of a segment connecting the origin and the end of a curve composed of concatenated continuous components of the curve. The respective kinematic definition is

$$\overline{ϕ} = {\overline{ϕ}}_{t} = arg ( {\int }_{0}^{T} ⅆ {tⅇ}^{ⅈϕ ( t )} ) , \qquad ( 40 )$$

and its geometric meaning is illustrated in FIG. 11 (b).

For a connected segmented curve, the preferred direction can be expressed as

$$\overline{ϕ} = {\overline{ϕ}}_{l} = arg ( {\int }_{0}^{S} ⅆ {sⅇ}^{ⅈϕ ( s )} + {\sum }_{i} δ l ( {s}_{i} ) {ⅇ}^{ⅈϕ ( {s}_{i} )} ) , \qquad ( 41 )$$

and its geometric meaning, as shown in FIG. 11 (c), is the direction of a segment connecting the origin and the end of the curve.

As a sensible alternative, the preferred direction can be defined as the direction of a vector connecting the origin of a curve with its center, for example:

$$\overline{ϕ} = {\overline{α}}_{s} = arg ( {\overline{z}}_{s} ) , \\ {\overline{z}}_{s} = {\int }_{0}^{S} ⅆ s ( 1 - \frac{s}{S} ) {ⅇ}^{ⅈϕ ( s )} + {\sum }_{i} δ l ( {s}_{i} ) ( 1 - \frac{{s}_{i}}{S} ) {ⅇ}^{ⅈϕ ( {s}_{i} )} , \qquad ( 42 )$$

as shown in FIG. 11 (d).

A normalized aligned curve can be expressed in an intrinsic form as

$$ξ ( s ) = \frac{1}{S} [ {\int }_{0}^{S} ⅆ {s}^{′} {ⅇ}^{ⅈφ ( {s}^{′} )} + {\sum }_{i} δ l ( {s}_{i} ) {ⅇ}^{ⅈφ ( {s}_{i} )} θ ( s - {s}_{i} ) ] , \qquad ( 43 )$$

where φ(s)=φ(s)−\overline{φ}. In polar coordinates, ξ(s) can be written as

$$\begin{matrix}ξ ( s ) = r ( s ) {ⅇ}^{ⅈα ( s )} , \\ r ( s ) = \frac{1}{S} \vert z ( s ) \vert , \\ α ( s ) = arg [ z ( s ) ] - \overline{α} ,\end{matrix} \qquad ( 44 )$$

where z(s) is given by equation (12) and the preferred direction \overline{α} is defined as

$$\overline{α} = arg ( {\int }_{0}^{S} ⅆ s {\vert z ( s ) \vert}^{2} {ⅇ}^{ⅈϕ ( s )} ) . \qquad ( 45 )$$

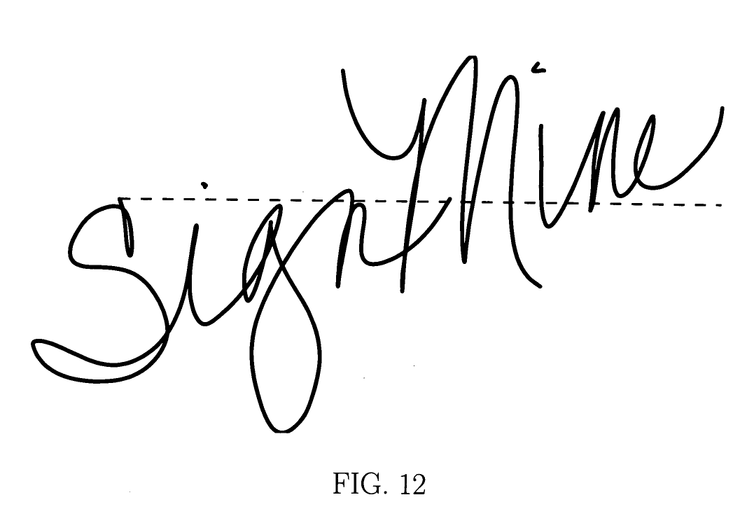

An example of a curve aligned along the preferred direction defined by equation (45) is shown in FIG. 12.

### 7 Robust (Coincidence) Segmentation of a Digitally-sampled Curve

Representation of a piecewise continuous curve by a discrete record always blurs the distinction between continuous and discontinuous portions of the curve. For example, the distance between the consecutive data points in a record acquired by a tablet device is proportional to the speed of the tip of the writing utensil and can exceed the distance between the end of one segment and the beginning of the other. Thus segmentation based on the distance between the consecutive data points may fail to accurately represent the curve as a collection of records corresponding to the underlying continuous segments.

The formalism of § 1.3 allows us do develop a simple robust procedure for segmentation of a digital record. Notice that, as follows from equation (9), the differential δl is zero everywhere except at the ‘breaks’ between the continuous components. Let us define the double differential δ²l as

$${δ}^{2} l ( o ) = {lim}_{ɛ -> 0} δ l ( o + ɛ ) - δ l ( o ) , \qquad ( 46 )$$

and point out that δ²l also vanishes at continuous components while taking finite absolute values at discontinuities.

Consider now a curve sampled at discrete values of o, and the finite-difference equivalents of the differentials δl and δ²l:

$$\begin{matrix}Δ {l}_{i} = \vert z ( {o}_{i + 1} ) - z ( {o}_{i} ) \vert , \\ and & ( 47 ) \\ \vert {Δ}^{2} {l}_{i} \vert = \frac{1}{2} [ \vert Δ {l}_{i + 1} - Δ {l}_{i} \vert + \vert Δ {l}_{i} - Δ {l}_{i - 1} \vert ] . & ( 48 )\end{matrix}$$

Notice that both Δlᵢ and |Δ²lᵢ| will have pronounced maxima whenever a discontinuity lies between oᵢ and oᵢ₊₁. On the other hand, the extrema of Δlᵢ will correspond to the zeros of |Δ²lᵢ| at continuous portions of the curve.

Thus a robust (coincidence) segmentation of a digitally-sampled curve can be performed using the following algorithm: Discontinuities can be found as coincident maxima of Δlᵢ and |Δ²lᵢ| lying above a certain threshold (or respective thresholds). Since the number of discontinuities is generally much smaller than the total number of the data points in any meaningful digital record, a simple choice for a threshold would be a high percentile of the values of Δlᵢ and/or |Δ²lᵢ|. An example of a formal procedure for determining the percentile (quantile) value(s) for the segmentation threshold(s) is provided in § 7.1.

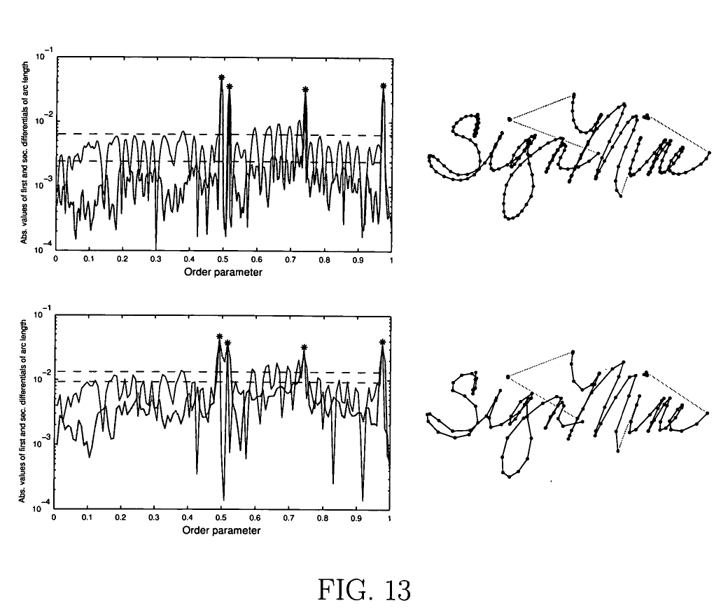

FIG. 13 illustrates the performance of the algorithm on two curves with different sampling (see right-hand panels). The panels on the left show the first differential Δlᵢ by the solid black line, the second differential |Δ²lᵢ| by the solid gray line, and the respective thresholds (90th percentiles) by the dashed lines. The discontinuous points are indicated by the asterisks. In the right-hand panels, the data points (dots) belonging to continuous portions of the curves are connected by the black lines.

### 7.1 Example of an Iterative Procedure for Setting the Threshold(s) of Coincidence Segmentation

A quantile value of the segmentation threshold can be determined as a solution of the following equation:

$$q \approx 1 - α \frac{N ( q )}{{N}_{0}} , \qquad ( 49 )$$

where N(q) is the total number of discontinuities, for all digital records of the line objects in the database, determined through coincidence segmentation with the threshold set at 0≦q≦1, N₀ is the total number of the data points in said all digital records, and α≧1 is a number of order unity. Equation (49) can be solved, for example, by an iterative procedure starting with an arbitrary initial guess for q (for example, q=0 or q=½).

### 8 Example of Online Database of Handwritten Signatures

In this section, we provide a brief description of a complete life-cycle software package for signature identification and verification. The SIGNMINE engine stands in the middle, it has image processing tools and internal formats built-in and incorporated with the database. The input data comes from image acquisition devices like scanners or pressure-sensitive tablets, the output is interfaced for other applications (web systems, control systems, etc.). In general, the SIGNMINE engine uses drivers to integrate with many off-the-shelf image acquisition devices and standardized software platforms, and connectors to interface with legacy and commonly used authentication systems and applications. The SIGNMINE package has applicability in all areas where signature identification or verification is desirable or required.

The software package for automated handwritten signature recognition, verification, and mining, SIGNMINE, includes (i) signature acquisition tools, (ii) a searchable signature database (the SIGNMINE engine), and (iii) an online interface. The SIGNMINE package currently supports pressure sensitive tablets which allow recording both geometric (signature contours, shapes, etc.) and kinematic/dynamic characteristics (pressure, time stamps, etc.).

The SIGNMINE algorithm represents signatures given by discrete data in terms of continuous quantities, and enables a novel extremely effective approach to analysis of human handwriting. SIGNMINE algorithm has capabilities far surpassing the current state-of-art and the products of the industry leaders. The main features of SIGNMINE can be summarized as follows:
Very high accuracy of signature identification and verification, for example better than 99.999% accuracy when pressure data is available. Even without pressure information, SIGNMINE provides more than 99.9% accuracy, which, when used in combination with another security measure (for example, voice authentication), offers more than 1,000-fold enhancement of such a measure.
Inexpensive hardware. If 99.9% accuracy is sufficient, then no pressure information is required and almost any tablet device can be employed for signature acquisition. In addition, SIGNMINE can use data acquired by such devices as touchpads and touchscreens through fingertip writing.
Very high level of robustness with respect to variations in quality of acquired signatures. Signatures recorded by various devices with different characteristics (for example, different spatial and timing resolution) can be processed accurately and reliably.
Intrinsic database learning capabilities, ensuring that the performance improves as the database grows.

Unlike the competing algorithms which rely on simplistic distance measures of similarity, SIGNMallows construction of a large variety of non-equivalent metrics for signature comparison. Even though the individual variations in these measures can be relatively large, they are typically much smaller than the respective variations across the whole database of signatures. As the number of such metrics increases, so does the robustness and selectivity of verification and identification performed by the SIGNMINE algorithm.

The SIGNMINE engine is a key component of the software package, it includes the tools for generating multiple distributions, the relational database, scoring mechanisms, and decision making tools. Signature databases are currently considered to be a part of multimedia databases, and they differ from traditional information databases based on textual searching. This attributes to the fact that a text-based query is computationally more efficient to perform than the image analysis and comparison. Since a database of signatures based on textual searching alone is inadequate for a qualitative analysis in the areas of biometrics and security, the SIGNMINE implementation incorporates distinctions based on the image data. Some of the components of our solution include the server-based database (a relational database), different types of image acquisition tools (pressure sensitive tablets), signature processing and classification algorithms (external modules), and a web-based user interface (dynamically generated web pages). SIGNMINE engine is a robust and scalable technology designed to support behavioral authentication mechanisms based on handwritten electronic signatures for identification and verification.

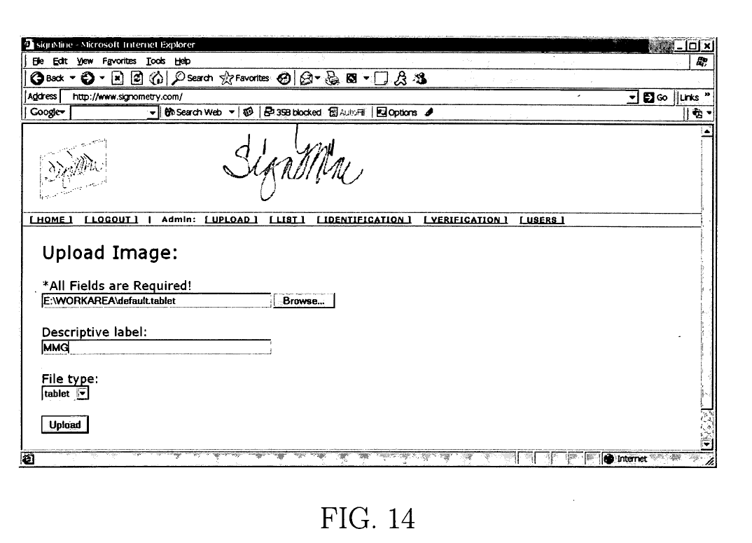

The web-based interface has five basic modules: login, upload, list, verify, and identify. The database is protected against any unauthorized access by the login module. After the successful login, the user is given administrative rights to the upload and list functions. The upload module allows the user to upload a signature image providing a descriptive keyword (e.g., a person's name), and to choose a file type from the drop down list (see FIG. 14). After clicking submit, the web script updates the database and generates all the necessary distributions for the given image.

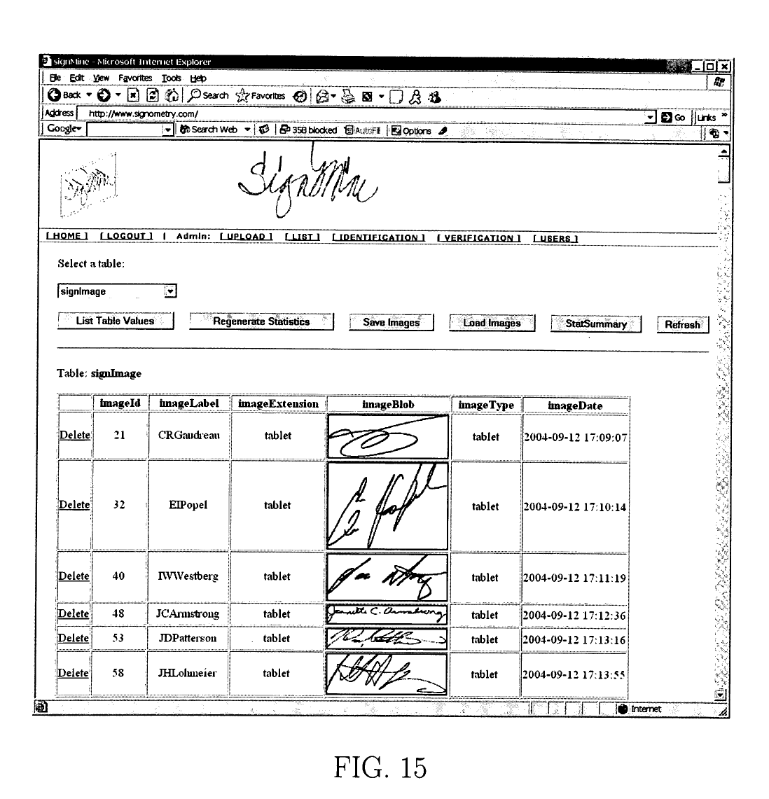

The list script creates a table, listing all the data from the database. For signature images, the data are listed in the form of thumbnails (see FIG. 15). A button labelled regenerate is also available for administrative users to automatically regenerate distributions for all signatures. This is especially useful when a new classification feature is added to SIGNMINE engine. By clicking regenerate, all previously stored data are recalculated every signature in the database. Images can be inspected and deleted when necessary.

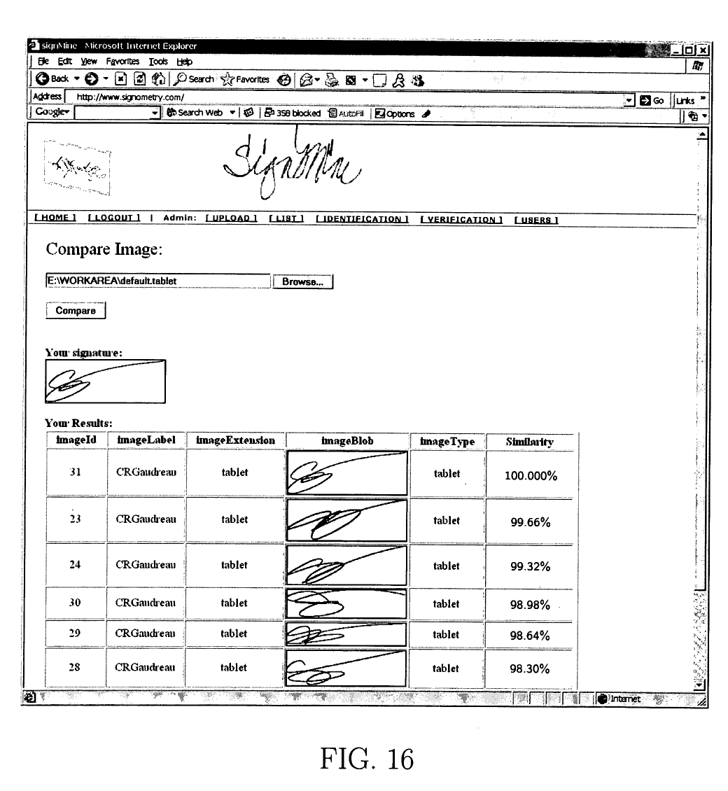

The only functions accessible to non-administrative users are verify and identify, because they do not alter the database. Identify is a module that allows the user to upload a signature image, generate distribution data, and compare the generated data against the data of all images in the database. The verification module collects the keyword label from the user and compares the generated data against a limited set of images. Both modules create a table displaying the testing signature and listing the top ten signatures from the database along with similarity ratings (see FIG. 16).

### Articles of Manufacture

Various embodiments of the invention may include hardware, firmware, and software embodiments, that is, may be wholly constructed with hardware components, programmed into firmware, or be implemented in the form of a computer program code.

Still further, the invention disclosed herein may take the form of an article of manufacture. For example, such an article of manufacture can be a computer-usable medium containing a computer-readable code which causes a computer to execute the inventive method.

1. A method for analysis of line objects, the method comprising:
(a) defining a representation of a line object in terms of a plurality of piecewise continuous variables; and
(b) constructing one or more modulated functions of said variables, where said modulated functions are selected from the group consisting of modulated distribution functions and modulated density functions.

2. The method of claim 1 further comprising:
calculating statistics of said modulated functions wherein said statistics are descriptive of the properties of said modulated functions.

3. The method of claim 1 further comprising:
comparing one or more of said modulated functions with respective reference modulated functions.

4. The method of claim 3 wherein said reference modulated functions are provided by a database.

5. The method of claim 4 further comprising:
calculating selectivity ranks of said modulated functions, and utilizing said selectivity ranks for retrieving said reference modulated functions from said database.

6. The method of claim 3 wherein said comparison is through calculation of a weighted sum of different comparison measures.

7. A method for representing a discrete set of reference points by a continuous function, said discrete set having an ordered list of arguments of said reference points and an ordered list of the respective values of said reference points, the method comprising:
(a) determining increments in said arguments of said reference points;
(b) determining increments in said values of said reference points;
(c) determining reference increments in a kernel, said kernel having a width parameter such that in the limit of said width parameter approaching zero said kernel approaches a ramp function;
(d) determining an nth derivative of a difference of said continuous function and an offset value as a sum of all products of said increments in said values and said nth order derivatives of the respective ratios of said reference increments to said increments in said arguments.

8. The method of claim 7 wherein at least one derivative of said kernel is continuous.

9. A method for coincidence segmentation, the method comprising:
(a) defining a first difference as a finite difference equivalent of differential displacement along a connected segmented curve;
(b) defining a second difference as the absolute value of a finite differential equivalent of a double differential displacement along said connected segmented curve;
(c) finding discontinuities of said connected segmented curve as coincident maxima of said first difference and said second difference, said maxima lying above a coincidence threshold.

10. The method for coincidence segmentation as recited in claim 9 where a quantile value of said coincidence threshold is determined as an approximate solution of an equation where the difference between a unity and said quantile value is equal to the ratio of the total number of discontinuities determined through coincidence segmentation with said coincidence threshold set at said quantile value for all digital records of the line objects in a selection of said line objects to the total number of the data points in said all digital records, said ratio being multiplied by a factor greater than one, said factor being on the order of unity.
